(19) United States
(12) Patent Application Publication
(10) Pub. No.: US 2007/0050814 A1
(43) Pub. Date: Mar. 1, 2007

(54) Method for forming EPG information including advertisement information in terrestrial DMB system

(75) Inventors: Jin-Woo Jeon, Seongnam-si (KR); Young-Jip Kim, Suwon-si (KR); Sun-Mi Kim, Seoul (KR); Byoung-Dai Lee, Seongnam-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/511,821

(22) Filed: Aug. 29, 2006

(30) Foreign Application Priority Data
Aug. 29, 2005 (KR) 2005-79171

(51) Int. Cl. H04N 5/445; G07G 1/14; G06F 17/00

(52) U.S. Cl. 725/40; 705/14; 715/513; 725/39

(57) ABSTRACT

A method is provided for a terrestrial DMB system to form EPG information that includes advertisement information, and XML-based schemas are defined and used for this purpose. Specifically, existing XML schemas regarding ensemble information, service information and program information have inserted therein the newly defined XML-based schemas so that provided advertising information can be displayed whenever EPG information is displayed.

### CLAIM OF PRIORITY

This application claims priority to an application entitled “Method For Forming EPG Information Including Advertisement Information In Terrestrial DMB System,” filed in the Korean Intellectual Property Office on Aug. 29, 2005 and assigned Serial No. 2005-79171, the contents of which are hereby incorporated by reference.

### BACKGROUND OF THE INVENTION

1. Field of the Invention

The present invention relates to a method for forming Electronic Programme Guide (EPG) information in a terrestrial Digital Multimedia Broadcasting (DMB) system, and more particularly to a method for forming eXtensible Markup Language (XML)-based EPG information in order to provide advertisement information through an EPG in a terrestrial DMB system.

2. Description of the Related Art

A DMB system is a system standard pioneered in Korea for the first time in the world in order to provide a multimedia broadcast service including video based on a Digital Audio Broadcasting (DAB) system, particularly Eureka-147. Eureka-147 is a European digital radio broadcasting standard for simultaneously providing both a high quality audio service of a CD grade and a data service. Further, DMB systems are classified into a satellite DMB system employing a satellite as a transmission medium, and a terrestrial DMB system employing a ground wave as a transmission medium.

The DMB system can provide various information including audio and data as well as video information. Specifically, the terrestrial DMB system services such information by transmitting each of a video service, an audio service and a data service in a frequency tag called an ensemble.

In such a terrestrial DMB system, it is important to provide EPG information. To this end, a proposal has been made to provide information through an XML scheme.

The XML scheme is a method in which the contents and the expressions of a document are separately transmitted. That is, a document writer may create the contents of the document without paying attention to the expressions of the document. Further, the XML scheme is characterized in that one XML document may be expressed in various ways by means of diverse style sheet documents.

The XML document itself is directed to the structural storage of information rather than the expression of information. Thus, in order to express an XML document, for example, in an HTML (Hyper Text Markup Language) style, it is necessary to separately make a style sheet document such as a CSS (Cascading Style Sheet) and an XSL (extensible Style Sheet Language).

FIG. 1 illustrates an example of a typical XML document-providing system for providing EPG information in a terrestrial DMB system.

As illustrated in FIG. 1, the XML document-providing system includes a word processor unit 100 for creating an XML document, a document receiver unit 200 for receiving the created XML document and interpreting the received XML document into a web document style, and a broadcast network 14 for interconnecting the word processor unit 100 and the document receiver unit 200.

The word processor unit 100 converts an input document 11 into the XML document through an XML creator 12, and transfers the XML document to the broadcast network 14. Here, the XML creator 12 expresses a document as only the contents of the document. Thus, in order to represent the XML document as a document such as an HTML document, the word processor unit 100 further includes a CSS/XSL processor 13 for providing a style sheet document.

The document receiver unit 200 interprets the XML document transferred through the broadcast network 14 by means of an XML interpreter 15, and represents the XML document as an HTML style document 16.

In order to generate XML based-EPG information for the terrestrial DMB system, the European Telecommunications Standards Institute (ETSI) has developed an XML-based EPG standard proposal (ETSI TS 101 818) for DAB. In the ETSI TS 101 818, an XML schema for a data broadcast is proposed and thus the XML-based EPG information is configured according to the proposed XML schema.

Generally, EPG information is intended to enable broadcast service users to select desired broadcast services or relevant contents by supplying the users with information about various services available to the users.

Since various types of terminals are used in a broadcast network, such EPG information needs to be flexible. In order to provide EPG information regardless of the types of terminals, the ETSI has defined an XML schema for a DAB service by means of XML.

As described above, the EPG defined by an ETSI is based on a DAB service. Currently, the Telecommunications Technology Association (TTA) in Korea is performing supplementary development for a terrestrial DMB service part, i.e., a video service-related part.

The XML schema defined by the ETSI TS 101 818 according to the DAB standard includes service information, schedule information and group information.

FIGS. 2a to 2c respectively illustrate service information, schedule information and group information according to the XML schema defined in the DAB standard.

FIG. 2a relates to the service information. The service information includes an ensemble tag 21 for specifying information about an ensemble, and a service tag 22 for specifying both information about a broadcast service and link information about an ensemble for which the broadcast service is provided. As illustrated in FIG. 2a, each service tag 22 is connected with an ensemble tag 21, and the service tag 22 is treated as a subordinate tag to the ensemble tag 21. One of the attributes of the service tag 22 is a format. A format defined by the existing DAB standard is as follows: audio (default); Dynamic Label Service (DLS); MOTSlideshow; MOTBWS; Transport Protocol Experts Group (TPEG); and Differential GPS (DGPS).

FIG. 2b relates to the schedule information. The schedule information includes a schedule tag 23 for specifying time information (schedule) for one or more services, a program tag 24 for specifying both information about programs and link information about a service available to a corresponding program, and an event tag 25 for specifying information about events related to a corresponding program. As illustrated in FIG. 2b, the schedule tag 23 is the uppermost tag, the program tag 24 is ranked below the schedule tag 23, and the event tag 25 is the lowermost tag.

FIG. 2c relates to the group information. The group information includes a parents group P tag 26 for specifying information about one group, n Son group S tags 27-1 to 27-n for specifying both the information about one group and link information about upper groups thereof, and a program tag 28 for specifying groups to which the program is linked. As illustrated in FIG. 2c, the group P tag 26 is the uppermost tag, the n group S tags 27-1 to 27-n are ranked next to the group P tag 26, and the program tag 28 is the lowermost tag.

Table 1 is an example of the service information in an XML schema defined by the existing ETSI TS 101 818.

TABLE 1
<xs:element name=“service” minOccurs=“0” maxOccurs=“unbounded”>
<xs:complexType>
<xs:sequence>
<xs:element name=“serviceID” minOccurs=“1”
maxOccurs=“unbounded”>
<xs:complexType>
<xs:attribute name=“id” type=“epg:dabIDType” use=“required”/>
<xs:attribute name=“type” default=“primary”>
<xs:simpleType>
<xs:restriction base=“xs:NMTOKEN”>
<xs:enumeration value=“primary”/>
<xs:enumeration value=“secondary”/>
</xs:restriction>
</xs:simpleType>
</xs:attribute>
</xs:complexType>
</xs:element>
<xs:group ref=“epg:serviceNameGroup” maxOccurs=“unbounded”/>
<xs:element name=“mediaDescription” type=“epg:mediaDescriptionType”
minOccurs=“0” maxOccurs=“unbounded”/>
<xs:element name=“genre” type=“epg:genreType”
minOccurs=“0”
maxOccurs=“unbounded”/
minOccurs=“0” maxOccurs=“unbounded”/>
<xs:element name=“parentalRating” type=“epg:parentalRatingType”
minOccurs=“0”/>
<xs:element name=“CA” type=“epg:CAType” minOccurs=“0”/>
<xs:element name=“keywords” type=“epg:keywordsType”
minOccurs=“0”/>
<xs:element name=“link” type=“epg:linkType” minOccurs=“0”
maxOccurs=“unbounded”/>
</xs:sequence>
<xs:attribute name=“version” type=“xs:integer”/>
<xs:attribute name=“format” default=“audio”>
<xs:simpleType>
<xs:restriction base=“xs:NMTOKEN”>
<xs:enumeration value=“audio”/>
<xs:enumeration value=“DLS”/>
<xs:enumeration value=“MOTSlideshow”/>
<xs:enumeration value=“MOTBWS”/>
<xs:enumeration value=“TPEG”/>
<xs:enumeration value=“DGPS”/>
<xs:enumeration value=“proprietary”/>
</xs:restriction>
</xs:simpleType>
</xs:attribute>
<xs:attribute name=“bitrate” type=“xs:nonNegativeInteger”/>
</xs:complexType>
</xs:element>
</xs:sequence>
<xs:attribute name=“id” type=“epg:ensembleIDType” use=“required”/>
<xs:attribute name=“version” type=“xs:integer”/>
</xs:complexType>
</xs:element>

As described above, the EPG standard proposal for a terrestrial DMB system can provide a general ensemble, service information and group information, but cannot provide information used for creating a new profit structure for a service provider.

In the current terrestrial DMB system, since many business models are not provided to a service provider, a corresponding service for each such model has not been provided. Accordingly, such an attempt for providing a DMB business model service is needed so that needs of both the service provider and service users can be satisfied. One such business model provides for delivery of advertisements to users through an EPG. Since such advertisement delivery through the EPG can provide a basis on which a service provider can expect an advertisement profit and service users can use the DMB service at lowered cost, it is expected to be a business model that meets the profit needs of the service provider and the cost-saving needs of service users.

However, the XML-based EPG standard proposal for the DAB proposed by the existing ETSI has not yet considered any method capable of providing such advertisements, and such a method is needed.

### SUMMARY OF THE INVENTION

Accordingly, the present invention provides a method for forming EPG information that includes advertisement information in a terrestrial DMB system. In a preferred embodiment, when the terrestrial DMB system provides an EPG, an XML schema for an attribute type for advertisements is provided, and this XML schema is inserted into different XML schemas for ensemble information, service information and program information, so that it is possible to provide advertisement information.

In accordance with one aspect of the present invention to provide, when a terrestrial DMB system displays advertisement information in an EPG, the advertisement information comprises texts, images, videos and audios, etc., so that a service provider can create advertisement business models in various ways.

In accordance with another aspect of the present invention, there is provided a method for forming EPG information including advertisement information in a terrestrial Digital Multimedia Broadcasting (DMB) system, the method including:

extracting, by a service provider of the terrestrial DMB system, information for forming the EPG information;

generating eXtensible Markup Language (XML) schemas regarding ensemble information, service information and program information;

determining whether to provide advertisement information through the EPG information;

when the advertisement information is to be provided through the EPG information, performing the steps of:
extracting advertisement information;
specifying an XML-based schema having an element for advertisements using the extracted advertisement information;
inserting the specified XML-based schema s into at least one of the generated XML schemas; and
providing a service user with said at least one XML schema.

### BRIEF DESCRIPTION OF THE DRAWINGS

The above and other features and advantages of the present invention will be more apparent from the following detailed description taken in conjunction with the accompanying drawings, in which:

FIG. 1 illustrates a block diagram of the general architecture of an XML document-providing system for providing EPG information in a terrestrial DMB;

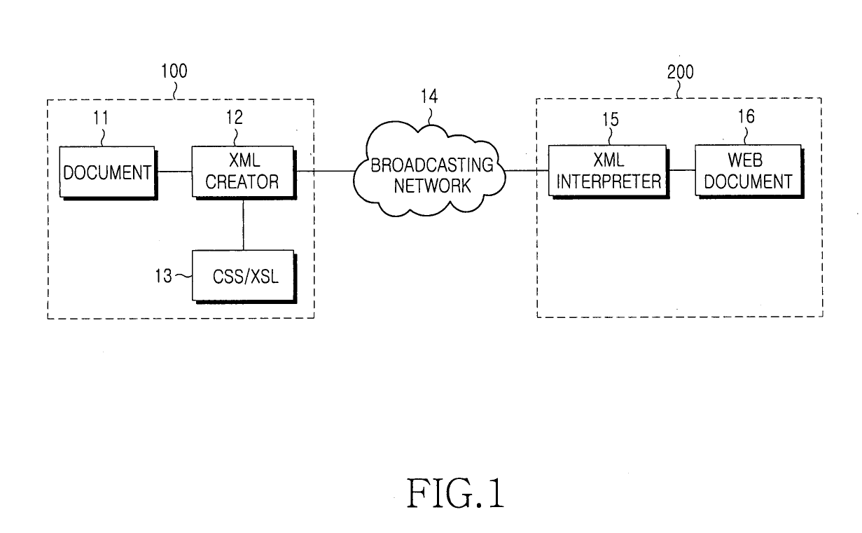

FIGS. 2a to 2c respectively illustrate service information, schedule information and group information according to XML schemas defined by a DAB standard;

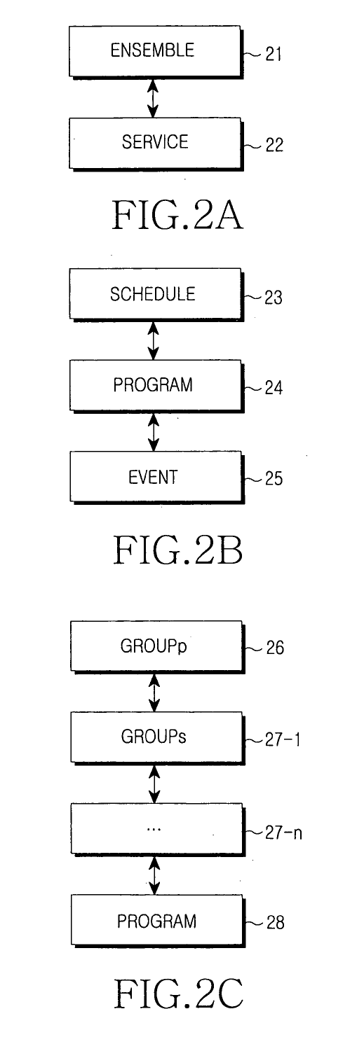

FIG. 3 illustrates a flow diagram of a method for forming EPG information including advertisement information in a terrestrial DMB system according to one embodiment of the present invention;

FIG. 4 illustrates an advertisement display screen according to a first embodiment of the present invention; and

FIG. 5 illustrates an advertisement display screen according to a second embodiment of the present invention.

### DETAILED DESCRIPTION OF THE INVENTION

Embodiments of the present invention are described in detail herein below with reference to the accompanying drawings. For the purposes of clarity and simplicity, a detailed description of known functions and configurations incorporated herein will be omitted as it may obscure the subject matter of the present invention.

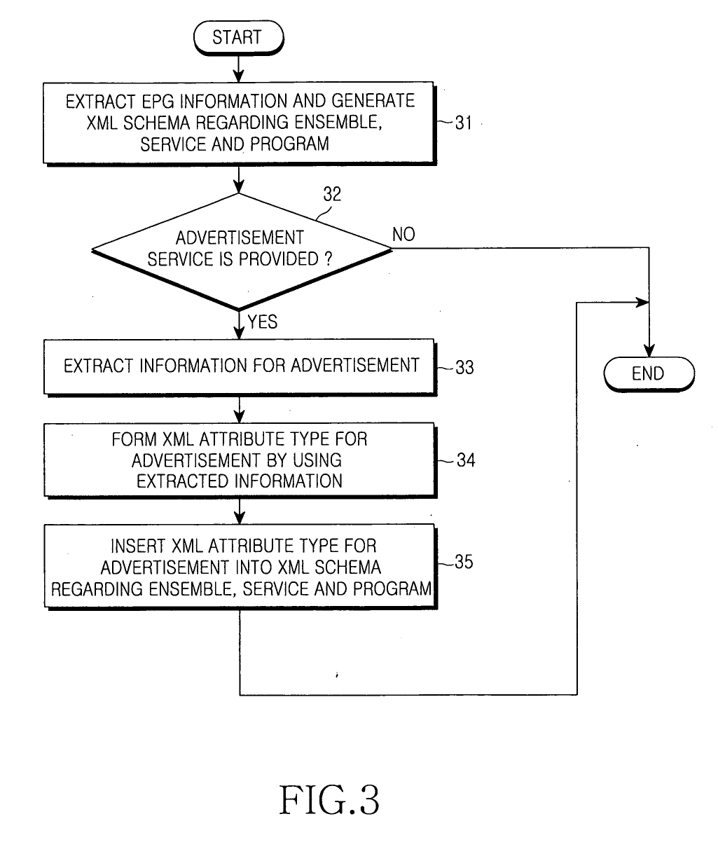

FIG. 3 is a flow diagram illustrating a method for forming EPG information including advertisement information, in a terrestrial DMB system, according to one embodiment of the present invention.

Referring to FIG. 3, a service provider of the terrestrial DMB system extracts information for forming an EPG, and generates XML schemas regarding ensemble information, service information and program information at step 31. Further, the service provider determines whether to provide advertisement information through the EPG at step 32. If the advertisement information is not provided through the EPG, the service provider provides a service user with the XML schemas generated at step 31, thereby allowing the service user to use an EPG service.

However, if the advertisement information is to be provided through the EPG, the service provider extracts information for advertisements, which includes information necessary for configuring an advertisement at step 33. The information for advertisements includes Uniform Resource Location (URL) information including a website address, a phone number and a mail address in which supplementary information of advertisements exists, mimevalue information for reporting the type of data existing in the location indicated by the URL information, language information for reporting languages used for indicating the content of an advertisement, description information including the content of a text advertisement, and expiry time information for reporting advertisement expiry time.

Specifically, the URL information may also include a location in which various materials and application programs, i.e. T-commerce, M-commerce and extra application programs, can be downloaded. The mimevalue information reports the type of data existing in the location indicated by the URL information, and may also indicate the type of data including images, videos, audios, etc., or the existence of application programs to be downloaded. Further, the description information including the content of a text advertisement corresponds to a necessary item, and preferably supports 180 bytes.

Then, the service provider defines an XML-based element for advertisements by means of the extracted information, and forms an XML schema having an attribute type about the element at step 34.

According to the embodiment of the present invention, the element for providing advertisement information is defined as <advertisement>. This element <advertisement> has an attribute type of “advertisementType”.

Table 2 illustrates an XML schema that defines the “advertisementType” as described above.

TABLE 2
<!-- ############################################################## -->
<!-- Definition of advertisementType -->
<!-- ############################################################## -->
<xs:complexType name=“advertisementType”>

<xs:attribute name=“url” type=“dab:urlType”/>
<xs:attribute name=“mimeValue” type=“mimeType”/>
<xs:attribute ref=“xml:lang” default=“en”/>
<xs:attribute name=“description” use=“required”>

<xs:simpleType>

<xs:restriction base=“xs:string”>

<xs:maxLength value=“180”/>

</xs:restriction>

</xs:simpleType>

</xs:attribute>
<xs:attribute name=“expiryTime” type=“timePointType”/>

</xs:complexType>
<!-- ############################################################## -->
<!-- Definition of urlType-->
<!-- ############################################################## -->
<xs:simpleType name=“urlType”>
<xs:restriction base=“xs:anyURl”>
<xs:whiteSpace value=“collapse”/>
<xs:pattern value=“
((crid|CRID|tel|mailto|postal|http|dab):(//|\+|SMS=)?)?([a-zA-Z0-9]|\.|@|%|\−
|/|_|\+|\?|=|;){1,} ”/>
</xs:restriction>
</xs:simpleType>

Referring to table 2, the “advertisementType” includes a URL attribute, a mimeValue attribute, a language attribute, a description attribute, and an expiryTime attribute. Each attribute is connected with the information of advertisements.

That is, the URL attribute relates to the URL information including a website address, a phone number and a mail address in which supplementary information of advertisements exists, the mimeValue attribute relates to the mimevalue information for reporting the type of data existing in the location indicated by the URL information, the language attribute relates to the language information for reporting languages used for indicating the content of an advertisement, the description attribute relates to the description information including the content of a text advertisement, and the expiryTime attribute relates to the expiry time information for reporting advertisement expiry time.

Specifically, the URL attribute may also include a location in which various materials and application programs, i.e. T-commerce, M-commerce and extra application programs, can be downloaded. The mimevalue attribute reports the type of data existing in the location indicated by the URL information, and may also indicate the type of data including images, videos, audios, etc., or the existence of application programs to be downloaded. Further, the description attribute including the content of a text advertisement corresponds to a necessary item, and is set to support the total 180 bytes.

Then, at step 35 the service provider inserts the formed schema of the attribute type based on the element for advertisements into the XML schemas for the ensemble information, the service information and the program information, which are generated in step 31. In such a case, the formed schema may be inserted into all three XML schemas, respectively, or may also be inserted into one of the three XML schemas.

Tables 3 to 5 respectively illustrate the XML schema for the ensemble information, the XML schema for the service information, and the XML schema for the program information.

TABLE 3
<xs:element name=“ensemble” maxOccurs=“unbounded”>
<xs:complexType>
<xs:sequence>
<xs:group ref=“epg:serviceNameGroup” maxOccurs=“unbounded” />
<xs:element name=“frequency” minOccurs=“0” maxOccurs=“unbounded”>
<xs:element name=“mediaDescription” type=“epg:mediaDescriptionType” minOccurs=“0”
maxOccurs=“unbounded” />
<xs:element name=“parentalRating” type=“epg:parentalRatingType” minOccurs=“0” />
<xs:element name=“CA” type=“epg:CAType” minOccurs=“0” />
<xs:element name=“keywords” type=“epg:keywordsType” minOccurs=“0” />
<xs:element name=“link” type=“epg:linkType” minOccurs=“0” maxOccurs=“unbounded” />
<xs:element name=“service” minOccurs=“0” maxOccurs=“unbounded”>
<xs:element name=“advertisement” type=“advertisementType” minOccurs=“0”
maxOccurs=“unbounded”/>
</xs:sequence>
<xs:attribute name=“id” type=“epg:ensembleIDType” use=“required” />
<xs:attribute name=“version” type=“xs:integer” />
</xs:complexType>
</xs:element>

TABLE 4
<!-- ##################################################################### --
>
<!-- Definition of service -->
<!-- ##################################################################### --
>
<xs:element name=“service” minOccurs=“0” maxOccurs=“unbounded”>
<xs:complexType>
<xs:sequence>
<xs:element name=“serviceID” minOccurs=“1” maxOccurs=“unbounded”>
<xs:complexType>
<xs:attribute name=“id” type=“epg:dabIDType” use=“required” />
<xs:attribute name=“type” default=“primary”>
<xs:simpleType>
<xs:restriction base=“xs:NMTOKEN”>
<xs:enumeration value=“primary” />
<xs:enumeration value=“secondary” />
</xs:restriction>
</xs:simpleType>
</xs:attribute>
</xs:complexType>
</xs:element>
<xs:group ref=“epg:serviceNameGroup” maxOccurs=“unbounded” />
<xs:element name=“mediaDescription” type=“epg:mediaDescriptionType” minOccurs=“0”
maxOccurs=“unbounded” />
<xs:element name=“genre” type=“epg:genreType” minOccurs=“0” maxOccurs=“unbounded”
/>
<xs:element name=“epgLanguage” type=“epg:dabLanguageType” minOccurs=“0”
maxOccurs=“unbounded” />
<xs:element name=“parentalRating” type=“epg:parentalRatingType” minOccurs=“0” />
<xs:element name=“CA” type=“epg:CAType” minOccurs=“0” />
<xs:element name=“keywords” type=“epg:keywordsType” minOccurs=“0” />
<xs:element name=“link” type=“epg:linkType” minOccurs=“0” maxOccurs=“unbounded” />
<xs:element name=“advertisement” type=“advertisementType” minOccurs=“0”
maxOccurs=“unbounded”/>
</xs:sequence>
<xs:attribute name=“version” type=“xs:integer” />
<xs:attribute name=“format” default=“audio”>
<xs:simpleType>
<xs:restriction base=“xs:NMTOKEN”>
<xs:enumeration value=“audio” />
<xs:enumeration value=“DLS” />
<xs:enumeration value=“MOTSlideshow” />
<xs:enumeration value=“MOTBWS” />
<xs:enumeration value=“TPEG” />
<xs:enumeration value=“DGPS” />
<xs:enumeration value=“proprietary” />
</xs:restriction>
</xs:simpleType>
</xs:attribute>
<xs:attribute name=“bitrate” type=“xs:nonNegativeInteger” />
</xs:complexType>
</xs:element>

TABLE 5
#################################################################### -->
<!-- Definition of dmbProgrammeType -->
<!-- ##################################################################### --
>
<xs:complexType name=“dmbProgrammeType”>
<xs:sequence>
<xs:group ref=“scheduleNameGroup” maxOccurs=“unbounded”/>
<xs:element name=“location” type=“locationType” maxOccurs=“unbounded”/>
<xs:element name=“programmeFormat” type=“programmeFormatType”/>
<xs:element name=“mediaDescription” type=“mediaDescriptionType” minOccurs=“0”
maxOccurs=“unbounded”/>
<xs:element name=“genre” type=“genreType” minOccurs=“0” maxOccurs=“unbounded”/>
<xs:element name=“parentalRating” type=“parentalRatingType” minOccurs=“0”/>
<xs:element name=“CA” type=“CAType” minOccurs=“0”/>
<xs:element name=“keywords” type=“keywordsType” minOccurs=“0”/>
<xs:element‘name=“memberOf”‘type=“memberOfType”‘minOccurs=“0”‘maxOccurs=“unbounded
”/>
<xs:element name=“link” type=“linkType” minOccurs=“0” maxOccurs=“unbounded”/>
<xs:element name=“advertisement” type=“advertisementType” minOccurs=“0”
maxOccurs=“unbounded”/>
<xs:element name=“programmeEvent” minOccurs=“0” maxOccurs=“unbounded”>
<xs:complexType>
<xs:sequence>
<xs:group ref=“scheduleNameGroup” maxOccurs=“unbounded”/>
<xs:element name=“location” type=“locationType” maxOccurs=“unbounded”/>
<xs:element name=“mediaDescription” type=“mediaDescriptionType” minOccurs=“0”
maxOccurs=“unbounded”/>
<xs:element name=“parentalRating” type=“parentalRatingType” minOccurs=“0”/>
<xs:element name=“genre” type=“genreType” minOccurs=“0” maxOccurs=“unbounded”/>
<xs:element name=“CA” type=“CAType” minOccurs=“0”/>
<xs:element name=“keywords” type=“keywordsType” minOccurs=“0”
maxOccurs=“unbounded”/>
<xs:element name=“memberOf” type=“memberOfType” minOccurs=“0”
maxOccurs=“unbounded”/>
<xs:element name=“link” type=“linkType” minOccurs=“0” maxOccurs=“unbounded”/>
</xs:sequence>
<xs:attribute name=“shortId” type=“ShortCRIDType” use=“required”/>
<xs:attribute name=“id” type=“CRIDType” use=“optional”/>
<xs:attribute name=“version” type=“xs:integer”/>
<xs:attribute name=“recommendation” type=“recommendationType” default=“no”/>
<xs:attribute name=“broadcast” type=“broadcastType” default=“on-air”/>
<xs:attribute ref=“xml:lang” use=“optional” default=“en”/>
</xs:complexType>
</xs:element>
</xs:sequence>
<xs:attribute name=“shortId” type=“ShortCRIDType” use=“required”/>
<xs:attribute name=“id” type=“CRIDType” use=“optional”/>
<xs:attribute name=“version” type=“xs:integer”/>
<xs:attribute name=“recommendation” type=“recommendationType” default=“no”/>
<xs:attribute name=“broadcast” type=“broadcastType” default=“on-air”/>
<xs:attribute name=“bitrate” type=“xs:nonNegativeInteger”/>
<xs:attribute name=“repeat” type=“repeatType”/>
<xs:attribute name=“live” type=“liveType”/>
<xs:attribute ref=“xml:lang” use=“optional” default=“en”/>
<!-- Added two lines by DMB group-->
</xs:complexType>

Hereinafter, the XML schema for the ensemble information, the XML schema for the service information, and the XML schema for the program information are described with reference to tables 3 to 5. In table 3,

<xs:element name=“advertisement” type=“advertisementType” minOccurs=“0” maxOccurs=“unbounded”/>

is inserted into the XML schema for the ensemble information. In table 4,

<xs:element name=“advertisement” type=“advertisementType” minOccurs=“0” maxOccurs=“unbounded”/>

is inserted into the XML schema for the service information. In table 5,

<xs:element name=“advertisement” type=“advertisementType” minOccurs=“0” maxOccurs=“unbounded”/>

is inserted into the XML schema for the program information. In this way, the element and the attribute type regarding advertisements are applied.

As described above, the method for forming the EPG information including the advertisement information in the terrestrial DMB system according to the present invention is described with reference to FIG. 3.

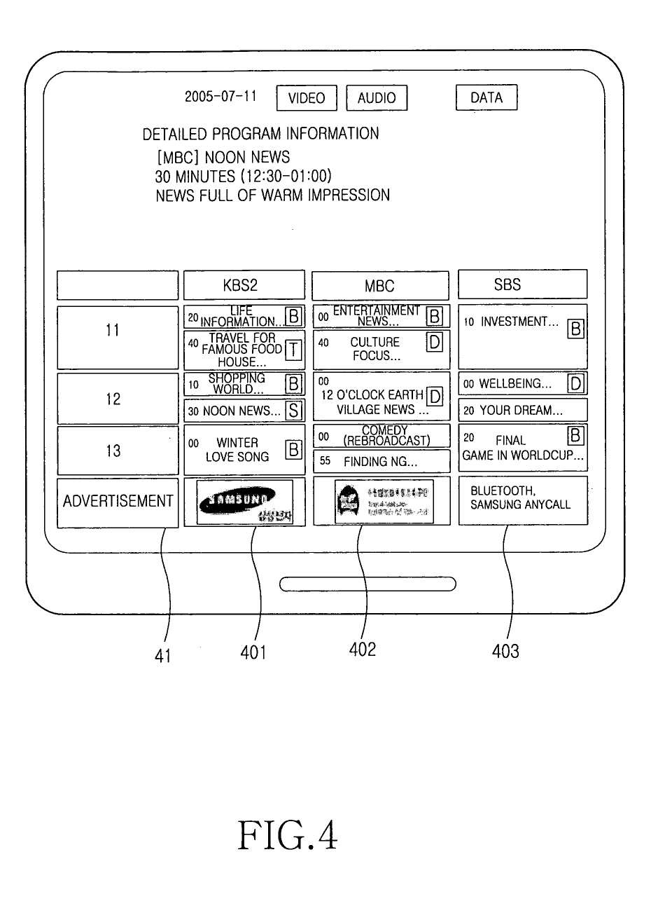

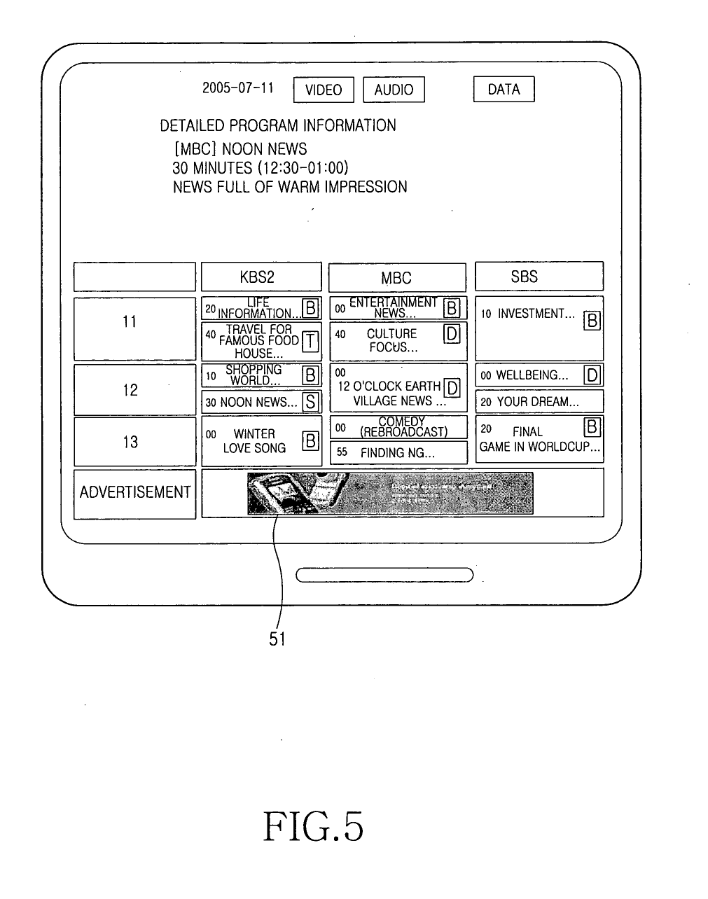

The advertisement information through the EPG as described above may be displayed in various ways. Hereinafter, a first embodiment for performing advertisement display according to channels/broadcasting time and a second embodiment for performing entire screen advertisement display will be described with reference to FIGS. 4 and 5.

FIG. 4 illustrates an advertisement display screen according to the first embodiment of the present invention.

Referring to FIG. 4, an advertisement 41 is located in a lower end portion of the EPG table, and the content 401 to 403 of the advertisement 41 may be differently displayed according to channels. Herein, the content of the advertisement may also be fixed according to channels or may also change according to broadcasting programs. Basically, a text content according to description information is first displayed on a screen. When the user's focus of a screen moves to the advertisement, detailed advertisement information is displayed on one of an upper end portion of the screen and a detailed advertisement information portion.

Further, websites for dynamic image advertisement reproduction, image download, music playback, etc., may be displayed through the URL information.

FIG. 5 is a diagram illustrating an advertisement display screen according to the second embodiment of the present invention.

Referring to FIG. 5, an advertisement is displayed in the entire area of a lower end portion of the EPG table through one window.

The above-described method according to the present invention can be realized by software and can be stored in a recording medium such as a CD ROM, a RAM, a floppy disk, a hard disk and a magneto-optical disk, so that a user can read such software by using a computer.

As described above, the present invention provides an EPG with advertisement information according to channels or broadcasting programs in a DMB broadcasting system, so that it is possible to create a new business model.

Further, the present invention provides advertisement information, so that it is possible to provide various derivation services including a T-commerce, etc., through a DMB service.

Although preferred embodiments of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for forming EPG information including advertisement information in a terrestrial Digital Multimedia Broadcasting (DMB) system, the method comprising:
extracting by a service provider of the terrestrial DMB system information for forming the EPG information;
generating eXtensible Markup Language (XML) schemas regarding ensemble information, service information and program information;
determining whether to provide advertisement information through the EPG information;
when the advertisement information is to be provided through the EPG information, performing the steps of:
extracting information for advertisements,
defining an XML-based element for advertisements using the extracted information,
forming a predetermined XML schema of an attribute type about the element; and
inserting the XML-based element for advertisements into at least one of the XML schemas selected from the group consisting of the ensemble information, the service information and the program information, and
providing a service user with said at least one XML schema having said XML-based element for advertisements inserted therein.

2. The method as claimed in claim 1, further comprising the step of, when the advertisement information is not provided through the EPG information providing the service user of the terrestrial DMB system with the generated XML schemas.

3. The method as claimed in claim 1, wherein the information for advertisements extracted includes Uniform Resource Location (URL) information having a website address, a phone number and a mail address in which supplementary information for advertisements exists, mimevalue information for reporting a type of data existing in a location indicated by the URL information, language information for reporting languages used for indicating a content of an advertisement, description information having a content of a text advertisement, and expiry time information for reporting advertisement expiry time.

4. The method as claimed in claim 1, wherein the predetermined XML schema of the attribute type is expressed by a following table,
```
<!-- #################################################### -->
<!-- Definition of advertisementType -->
<!-- #################################################### -->
<xs:complexType name=“advertisementType”>
    <xs:attribute name=“url” type=“dab:urlType”/>
    <xs:attribute name=“mimeValue” type=“mimeType”/>
    <xs:attribute ref=“xml:lang” default=“en”/>
    <xs:attribute name=“description” use=“required”>
        <xs:simpleType>
            <xs:restriction base=“xs:string”>
                <xs:maxLength value=“180”/>
            </xs:restriction>
        </xs:simpleType>
    </xs:attribute>
    <xs:attribute name=“expiryTime” type=“timePointType”/>
</xs:complexType>
<!-- ################################################### -->
<!-- Definition of urlType-->
<!-- ################################################### -->
<xs:simpleType name=“urlType”>
<xs:restriction base=“xs:anyURI”>
<xs:whiteSpace value=“collapse”/>
<xs:pattern value=“
((crid|CRID|tel|mailto|postal|http|dab):(//|\+|SMS=)?)?([a-zA-Z0-9]|\.-
|@|%|\-
|/|_|\+|\?|=|;){1,} ”/>
</xs:restriction>
</xs:simpleType>
```

5. The method as claimed in claim 1, wherein the XML schema regarding the ensemble information, the service information and the program information is expressed by a following table,
<xs:element name=“ensemble” maxOccurs=“unbounded”>
<xs:complexType>
<xs:sequence>
<xs:group ref=“epg:serviceNameGroup” maxOccurs=“unbounded” />
<xs:element name=“frequency” minOccurs=“0” maxOccurs=“unbounded”>
<xs:element name=“mediaDescription” type=“epg:mediaDescriptionType” minOccurs=“0”
maxOccurs=“unbounded” />
<xs:element name=“parentalRating” type=“epg:parentalRatingType” minOccurs=“0” />
<xs:element name=“CA” type=“epg:CAType” minOccurs=“0” />
<xs:element name=“keywords” type=“epg:keywordsType” minOccurs=“0” />
<xs:element name=“link” type=“epg:linkType” minOccurs=“0” maxOccurs=“unbounded” />
<xs:element name=“service” minOccurs=“0” maxOccurs=“unbounded”>
<xs:element name=“advertisement” type=“advertisementType” minOccurs=“0”
maxOccurs=“unbounded”/>
</xs:sequence>
<xs:attribute name=“id” type=“epg:ensembleIDType” use=“required” />
<xs:attribute name=“version” type=“xs:integer” />
</xs:complexType>
</xs:element>

6. The method as claimed in claim 1, wherein the XML schema regarding the service information is expressed by a following table,
<!-- ##################################################################### -->
<!-- Definition of service -->
<!-- ##################################################################### -->
<xs:element name=“service” minOccurs=“0” maxOccurs=“unbounded”>
<xs:complexType>
<xs:sequence>
<xs:element name=“serviceID” minOccurs=“1” maxOccurs=“unbounded”>
<xs:complexType>
<xs:attribute name=“id” type=“epg:dabIDType” use=“required” />
<xs:attribute name=“type” default=“primary”>
<xs:simpleType>
<xs:restriction base=“xs:NMTOKEN”>
<xs:enumeration value=“primary” />
<xs:enumeration value=“secondary” />
</xs:restriction>
</xs:simpleType>
</xs:attribute>
</xs:complexType>
</xs:element>
<xs:group ref=“epg:serviceNameGroup” maxOccurs=“unbounded” />
<xs:element name=“mediaDescription” type=“epg:mediaDescriptionType” minOccurs=“0”
maxOccurs=“unbounded” />
<xs:element name=“genre” type=“epg:genreType” minOccurs=“0” maxOccurs=“unbounded” />
<xs:element name=“epgLanguage” type=“epg:dabLanguageType” minOccurs=“0”
maxOccurs=“unbounded” />
<xs:element name=“parentalRating” type=“epg:parentalRatingType” minOccurs=“0” />
<xs:element name=“CA” type=“epg:CAType” minOccurs=“0” />
<xs:element name=“keywords” type=“epg:keywordsType” minOccurs=“0” />
<xs:element name=“link” type=“epg:linkType” minOccurs=“0” maxOccurs=“unbounded” />
<xs:element name=“advertisement” type=“advertisementType” minOccurs=“0”
maxOccurs=“unbounded”/>
</xs:sequence>
<xs:attribute name=“version” type=“xs:integer” />
<xs:attribute name=“format” default=“audio”>
<xs:simpleType>
<xs:restriction base=“xs:NMTOKEN”>
<xs:enumeration value=“audio” />
<xs:enumeration value=“DLS” />
<xs:enumeration value=“MOTSlideshow” />
<xs:enumeration value=“MOTBWS” />
<xs:enumeration value=“TPEG” />
<xs:enumeration value=“DGPS” />
<xs:enumeration value=“proprietary” />
</xs:restriction>
</xs:simpleType>
</xs:attribute>
<xs:attribute name=“bitrate” type=“xs:nonNegativeInteger” />
</xs:complexType>
</xs:element>

7. The method as claimed in claim 1, wherein the XML schema regarding the program information is expressed by a following table,
#################################################################### -->
<!-- Definition of dmbProgrammeType -->
<!-- #####################################################################
>
<xs:complexType name=“dmbProgrammeType”>
<xs:sequence>
<xs:group ref=“scheduleNameGroup” maxOccurs=“unbounded”/>
<xs:element name=“location” type=“locationType” maxOccurs=“unbounded”/>
<xs:element name=“programmeFormat” type=“programmeFormatType”/>
<xs:element name=“mediaDescription” type=“mediaDescriptionType” minOccurs=“0”
maxOccurs=“unbounded”/>
<xs:element name=“genre” type=“genreType” minOccurs=“0” maxOccurs=“unbounded”/>
<xs:element name=“parentalRating” type=“parentalRatingType” minOccurs=“0”/>
<xs:element name=“CA” type=“CAType” minOccurs=“0”/>
<xs:element name=“keywords” type=“keywordsType” minOccurs=“0”/>
<xs:element‘name=“memberOf”‘type=“memberOfType”‘minOccurs=“0”‘maxOccurs=“unbounded
”/>
<xs:element name=“link” type=“linkType” minOccurs=“0” maxOccurs=“unbounded”/>
<xs:element name=“advertisement” type=“advertisementType” minOccurs=“0”
maxOccurs=“unbounded”/>
<xs:element name=“programmeEvent” minOccurs=“0” maxOccurs=“unbounded”>
<xs:complexType>
<xs:sequence>
<xs:group ref=“scheduleNameGroup” maxOccurs=“unbounded”/>
<xs:element name=“location” type=“locationType” maxOccurs=“unbounded”/>
<xs:element name=“mediaDescription” type=“mediaDescriptionType” minOccurs=“0”
maxOccurs=“unbounded”/>
<xs:element name=“parentalRating” type=“parentalRatingType” minOccurs=“0”/>
<xs:element name=“genre” type=“genreType” minOccurs=“0” maxOccurs=“unbounded”/>
<xs:element name=“CA” type=“CAType” minOccurs=“0”/>
<xs:element name=“keywords” type=“keywordsType” minOccurs=“0”
maxOccurs=“unbounded”/>
<xs:element name=“memberOf” type=“memberOfType” minOccurs=“0”
maxOccurs=“unbounded”/>
<xs:element name=“link” type=“linkType” minOccurs=“0” maxOccurs=“unbounded”/>
</xs:sequence>
<xs:attribute name=“shortId” type=“ShortCRIDType” use=“required”/>
<xs:attribute name=“id” type=“CRIDType” use=“optional”/>
<xs:attribute name=“version” type=“xs:integer”/>
<xs:attribute name=“recommendation” type=“recommendationType” default=“no”/>
<xs:attribute name=“broadcast” type=“broadcastType” default=“on-air”/>
<xs:attribute ref=“xml:lang” use=“optional” default=“en”/>
</xs:complexType>
</xs:element>
</xs:sequence>
<xs:attribute name=“shortId” type=“ShortCRIDType” use=“required”/>
<xs:attribute name=“id” type=“CRIDType” use=“optional”/>
<xs:attribute name=“version” type=“xs:integer”/>
<xs:attribute name=“recommendation” type=“recommendationType” default=“no”/>
<xs:attribute name=“broadcast” type=“broadcastType” default=“on-air”/>
<xs:attribute name=“bitrate” type=“xs:nonNegativeInteger”/>
<xs:attribute name=“repeat” type=“repeatType”/>
<xs:attribute name=“live” type=“liveType”/>
<xs:attribute ref=“xml:lang” use=“optional” default=“en”/>
<!-- Added two lines by DMB group-->
</xs:complexType>
